(19) United States
(12) Patent Application Publication
(10) Pub. No.: US 2004/0201487 A1
(43) Pub. Date: Oct. 14, 2004

(54) Alarm

(76) Inventors: Alan Howard Benson, Somerset (GB); Warwick Jonathan David Camp, Somerset (GB)

Correspondence Address: NIXON & VANDERHYE, PC, 1100 N GLEBE ROAD, 8TH FLOOR, ARLINGTON, VA, 22201-4714, US

(21) Appl. No.: 10/486,975

(22) PCT Filed: Aug. 5, 2002
(86) PCT No.: PCT/GB02/03595

(30) Foreign Application Priority Data
Aug. 14, 2001 (GB) 0119747.4

(51) Int. Cl. G08B 21/00

(52) U.S. Cl. 340/666; 340/606

(57) ABSTRACT

An alarm system comprising a resilient foam pad contained within a cover, said cover being provided with air flow detector arranged to detect air leaving the cover in response to the application of a weight to the foam pad, and/or air entering the cover in response to the removal of at least some of said weight, and signalling means responsive to said detector. This system is particular useful for monitoring the movements of patients including babies, in and out of their beds or cots.

The present invention relates to an alarm system that can be used to detect for example when a person, such as a patient or a child, has left their bed or cot.

There is frequently a need to provide an indicator or alarm signal to carers or guardians as to when a person including a child, in their care leaves their bed. Following incidents of the kidnapping of babies from hospital cots, this may be required in a maternity or children's ward in a hospital for security purposes. Automatic detection of removal of a baby from a cot would prevent unauthorised removal of the baby from the hospital. Bed alarms to monitor the movement of patients, for example to detect when patients, such as confused or elderly patients, leave their beds or chairs may also be required, for example in care homes, in geriatric wards, sheltered housing or nursing homes, or even in a home environment.

WO 90/10281 describes a bed alarm system intended for use with patients in care. The alarm system in that case utilises an electrical pressure sensor device, which is placed under the mattress. When the bed is occupied, contacts within the sensor are closed and form part of an electrical circuit. The circuit is arranged to generate an alarm signal when no load has been applied to the pressure sensor for a predetermined time period.

In such devices however, the positioning of the pressure sensor in the bed is critical in determining whether contact may be maintained. Movement of the patient in the bed, for example when a person sits up in the bed or swings their legs over the side of the bed to sit on it, may release the contacts and give rise to false alarms. This makes the devices particularly unsuitable for use in babies' cots for example, where movement of the baby around the cot may mean that load is removed from large areas of the cot for long periods.

U.S. Pat. No. 6,255,956 describes a seat operated switch and warning system, which utilises changes in pressure within an air cushion to monitor the movements of a person sitting on it. This is a relatively complex system however, and inflatable cushions are not always suitable for use as mattresses in beds. Furthermore, they are subject to punctures which render them inoperable.

According to the present invention there is provided an alarm system comprising a resilient foam pad contained within a cover, said cover being provided with air flow detector arranged to detect air leaving the cover in response to the application of a weight to the foam pad, and/or air entering the cover in response to the removal of the said weight, and signalling means responsive to said detector.

This arrangement allows for the movements of people (and if required also objects) to be monitored. In particular it allows the presence or absence of a person, including a child, on a bed or chair to be detected. The use of a resilient foam pad, which is, in effect, self-inflating, ensures that air flows automatically back into the cover when the weight is removed. This is particularly advantageous and avoids the problems associated with the use of air cushions and the like.

In particular, the air flow detector comprises one or more valves. A particular example is a pressure/vacuum switch.

The expression “pressure/vacuum switch” used herein refers to switches of conventional type, which may respond to increases or decreases in pressure.

The pressure vacuum switch may be arranged to open to allow air to enter the cover when the air pressure within the cover drops below ambient pressure, for instance as a results of the self-inflation of the foam pad in response to the removal of the weight from it. Alternatively or additionally, the switch may be arranged to open to allow air to leave the cover when a weight is applied to the pad.

However in a particularly preferred embodiment, the detector further comprises a non-return pressure release valve, which is also provided in the cover and is arranged to allow air to be released from the cover when pressure is applied to the pad. This release system ensures that the system operates correctly, even if a weight is applied suddenly to the pad.

The signalling means is arranged so that it is responsive to the opening of the pressure/vacuum switch or the pressure release valve, or to the movement of air through said pressure/vacuum switch or pressure release valve, depending upon what is being monitored in any particular case.

The cover used is suitably a gas-impermeable or substantially gas-impermeable cover to ensure that a good flow of air passes through the valves when the pressure on the pad changes.

Preferably the cover is gas impermeable. However, generally the alarm system will still be operable even when there are small punctures in the cover.

Generally, in the situations outlined above, the removal of the weight from the pad, when the person leaves or is lifted from a bed, cot or chair containing the pad is the action which is to be monitored. In these cases, the signalling means is suitably responsive to the opening of the pressure/vacuum switch or to movement of air into the cover through the pressure/vacuum switch.

This can be arranged in various ways as would be understood in the art. Generally speaking however, the switch contains a pair of electrical contacts arranged within a chamber, at least one of the contacts being moveable in response to a reduction in pressure within the chamber, to bring the contacts together and thus close an electrical circuit.

Conversely however, there may be situations where the introduction of a patient into a bed may need to be detected, for example in hospitals where bed occupancy is being monitored. In these cases, the signalling means is suitably arranged so that it is responsive to the opening of the non-return pressure release valve, or to the movement of air through said non-return pressure release valve. Alternatively or additionally, the pressure/vacuum switch may be operable in two ways, so that it is able to monitor not only air entering the cover, but also air leaving the cover when a weight of a body is applied to the pad. Such valves are available commercially, for example from Herga Electric Ltd, Bury St Edmunds UK as discussed below. In such cases, this valve may act as both the non-return pressure release valve and the pressure/vacuum switch of the system.

Again there may be various valve arrangements which allow this to be done, but in general, the switches work on the principle that the application of air pressure caused by air passing through the valve out of the cover forces two contacts together thus completing an electrical circuit.

The pad may be of any required size or thickness to fit onto a bed, cot, divan, chair or couch as required. In a particular embodiment, the system, and in particular the pad with the cover, constitutes a mattress suitable for use in a bed, cot, divan or couch, or where necessary may be placed directly on the ground.

Alternatively, the system may be used with or without a conventional mattress, which may be placed on top or below it. In this case, the pad is suitably shaped so that that it extends substantially across the surface area of the mattress.

The pad may be of any resilient foam material, such as polyurethane, polyester or polyacylate foams. These may be of various grades according to its prospective use. For example a baby would require the lightest foam, which is the softest, whereas, in other applications, firmer grades of foam, which are nonetheless resilient, may be used.

The pad cover is suitably of a material that is flexible and preferably gas impermeable, such as polyester, which may be coated for example with a polyurethane and/or fluorochemical coating. Examples of such materials are obtainable from Gelvenor Textiles (South Africa). For reasons of hygiene, a removable outer cover can be utilised, an example being the cot mattress covers currently in use within National Health Maternity Units.

Mattresses comprising covered pads which are suitable for use in the system of the invention are commercially available.

In a particularly preferred embodiment, the pad with the cover may be rolled up for storage. In order to facilitate this, strips of tape or Velcro™ may be provided on a surface of the cover, and arranged to secure the pad in the rolled position. A separate cover for the rolled pad may also be provided.

The pressure release valve and the pressure/vacuum switch may be located at any convenient position around the perimeter of the pad, or even embedded within the pad and are in sealing relationship to the cover.

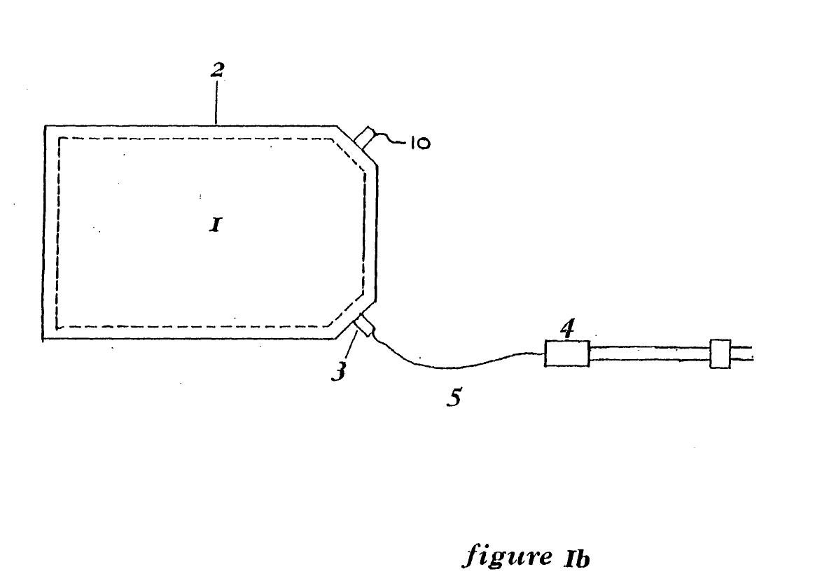

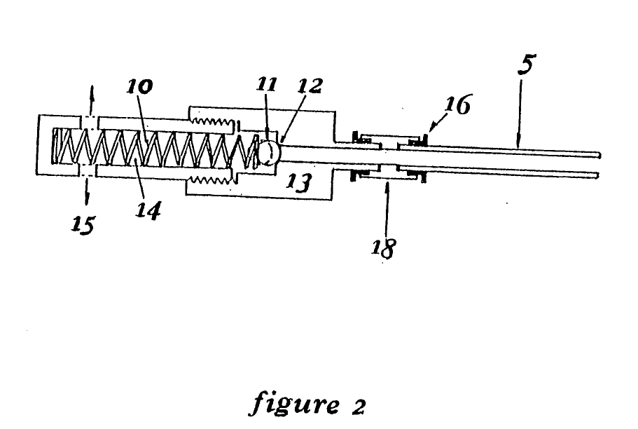

Suitable pressure release valves are manufactured by Becatech Ltd. An example is shown in FIG. 2 hereinafter. The setting of the pressure release valve will, in general, control the sensitivity of the system as this will determine how much air is evacuated from within the cover for a given pressure applied.

The pressure release valve is suitably set in accordance with the size of the pad and the likely loads, to ensure that an appropriate volume of air is evacuated from the cover when a pressure is applied to it. The pressure release valve used may be of variable setting, so that they respond to different pressures. This may be helpful when the system is used to accommodate patients of differing weights sequentially.

However, it has generally been found that the system requires little or no adjustment, even when widely different weights are applied to the pad.

Pressure Relief Valves suitable for applications where pressure adjustment is not required are available in various forms for example, from RS Components and Premier Farnell.

Herga manufacture a miniature adjustable pneumatic switch for very sensitive pressure, vacuum and differential pressure switching. This can be set for Normally Open or Normally Closed operation with adjustable air bleed version available. Manufacturer's list no's 6753-00 and 6753-oF.

In the unlikely event that a particular application should require some alteration from the default setting, the system may incorporate a coarse sensitivity adjustment control, suitably in the form of a second air outlet valve in the cover. This valve may comprise an adjustable screw-down cap to govern the speed at which the pad re-inflates. This controls the airflow directed through the vacuum switch providing a method of adjusting the sensitivity of the vacuum switch enabling air to be expelled from the bed at a faster or slower rate.

On compression of the pad, for example when a patient or a child lies in the bed or cot containing it, air is expelled from the foam, and exits from the cover through the non-return pressure release valve. On release of the pressure, for example when the patient leaves the bed or a child is lifted out of the cot, the resilient foam will return to its relaxed state, drawing air into the body of the pad. Mattresses of this type are known as “self-inflating”. When the pad is contained within a gas impermeable cover as in the system of the invention, this will set up a partial vacuum inside the cover, resulting in the operation of the pressure/vacuum switch, to allow air into the cover, thus restoring ambient pressure.

It is this action, which suitably activates the signalling system to provide an alert that the bed or cot has been vacated. However, if the patient or child merely moves around in the bed or cot, the resilient foam will react to the movement, by expanding in some places and compressing in others. However, there will be no overall change in the pressure applied to the pad, and thus no signal will be activated.

The signalling means suitably comprises an alerting device which gives a signal such as an audible signal like a bell or buzzer, a visible signal such as a light, or a combination of these as found for example in conventional “nursecall” devices. The alerting device is arranged to be triggered by a signal received either from the pressure/vacuum switch or the pressure release valve as appropriate. This signal may be generated by direct hard wire contacts, for example where the opening of the valves in response to air flow closes electrical contacts to complete a circuit which triggers the alerting device.

Where the user has their own signalling system, such as “nursecall system” found in hospitals, the signalling means may simply comprise a suitable connector which may be plugged into the existing system.

Alternatively, the system includes a radio-signalling device which is included in a circuit with the pressure/vacuum switch or the pressure release valve and which generates a radio-signal in response to the opening of the pressure/vacuum switch or the pressure release valve.

Such radio-signalling devices or radio-transmitters are well known in the art. They transmit a radio-signal and in particular a VHF signal to an alerting device which may be as described above, but in this case, may additionally comprise a radio-receiver or radio-pager. In the case of the radio-pager, the system may further comprise a transceiver to convert the VHF signal to a UHF signal which can be received by the pager. The precise nature of the connections will vary depending upon the nature of the alerting device, the switches used etc.

It may be preferable in a hospital environment, to use a radio-signalling device in the system, in order to avoid the need for trailing wires. Preferably such a system would be operated using a high security frequency to avoid interference with other systems operating in the hospital environment.

If desired, the system can be set so that a “confidence signal” is generated after preset periods, for example every 15 minutes or so, even when there has been no movement of a body in relation to the pad, so that the operator can be assured that the system is fully operational.

The system of the invention may be used singly or multiple units may be connected to a single signalling system as required. Where multiple units are used, the signalling system suitably has the facility to indicate which unit has been activated at any particular time. Thus for example in a hospital, the system is one which suitably indicates to the nurse, for example to a pager, an identifier of the bed such as the bed number, where a patient has vacated the bed.

Suitably, the system further comprises means for actuating the signalling system, so that the signalling system may be switched off when the bed or cot is not in use. Suitable actuating systems include simple switches, known key operated locking systems or an electronic locking system, which may be operated by entering an identification code. The code may be given to a limited number of people, for example to the mother of a baby in a cot in a maternity unit.

The signalling system will generally be electrically powered and may be supplied by mains electricity, or more preferably by means of a battery such as long-life magnesium or lithium battery. A conventional battery testing device may be included in the system, so that power within the battery may be monitored. This may for example comprise a light indicator, which is manually tested by compression of a switch, for example a switch reachable by application of a thin rigid object such as a pen or key, or an audible signalling device, which provides an intermittent sound when power within the battery is low.

In one embodiment, the system is supplied in modular form. Thus the pad within the cover with at least one integral air inlet/outlet pipe with tube connector is provided. The air inlet/outlet pipe with tube connector is suitably connectable to the pressure/vacuum switch and/or the pressure release valve by means of a detachable pneumatic tube, such as conventional 4 mm plastics tube. Automatic locking means such as spring-loaded locks, which fix the respective ends of the pneumatic tube into the air inlet/outlet pipes with tube connectors are well known in the art. Where a single air inlet/outlet pipe with tube connector is integrated into the cover, this may lead to both the pressure/vacuum switch and the pressure release valve for example by means of a branched pneumatic tube. Alternatively, two air inlet/outlet pipes with tube connectors may be provided in the cover, which are connectable to the pressure/vacuum switch and the pressure release valve respectively by means of two pneumatic tubes. At least part of the signalling system will be in electrical contact with either the pressure/vacuum switch or the pressure release valve as appropriate.

Individual elements adapted for use in the system form a further aspect of the invention.

In a particularly preferred embodiment, the signalling system, including in particular a radio-signalling means, are accommodated within a recess in the pad on the inside of the cover. Suitably, a moveable flap of material, such as the cover material is provided over the signalling system. This may be fixed on one side, but removeable on the other, for example by means of a temporary fixing such as a Velcro™ strip.

This provides a further degree of security, preventing the system from being easily disabled. In such an embodiment, the pressure/vacuum switch and the pressure release valve may also be substantially accommodated within the recess, provided they vent through the cover.

Additionally or alternatively, enhanced security may be achieved by including in the system a device to detect unauthorised removal or disconnection of any parts of the system. In particular, it may be arranged so that disconnection of parts of the system will trigger the alarm signalling system, or an additional alarm signalling system provided specifically for the purpose, either by means of a radio-signal or a hard wire connection.

The system of the invention provides many advantages for patient and child security. The alarm system is reliable and false alarms caused by movement and not by vacation of the bed or cot are minimised.

Further security against false alarms can be introduced by using software to ensure that the system only signals leaving and entering events sequentially. In other words, the system can be set so that the signalling system records when a patient has entered a bed. It will not then signal any further “entry events”, when air exits the cover, until after it has recorded an “exit event”. The converse can be applied following an “exit event”.

Furthermore, the system generally requires very little setting up. For instance, when the system measures only movement of air in one direction, it automatically resets itself for reuse.

It may be readily adapted for a variety of applications including the medical and security purposes outlined above. However, it may have other applications for example in detecting whether passengers vacate their seats during take-off and landing in aeroplanes, or as security devices for protecting valuable objects on display in museums and the like.

The invention will now be particularly described by way of example with reference to the accompanying diagrammatic drawings in which:

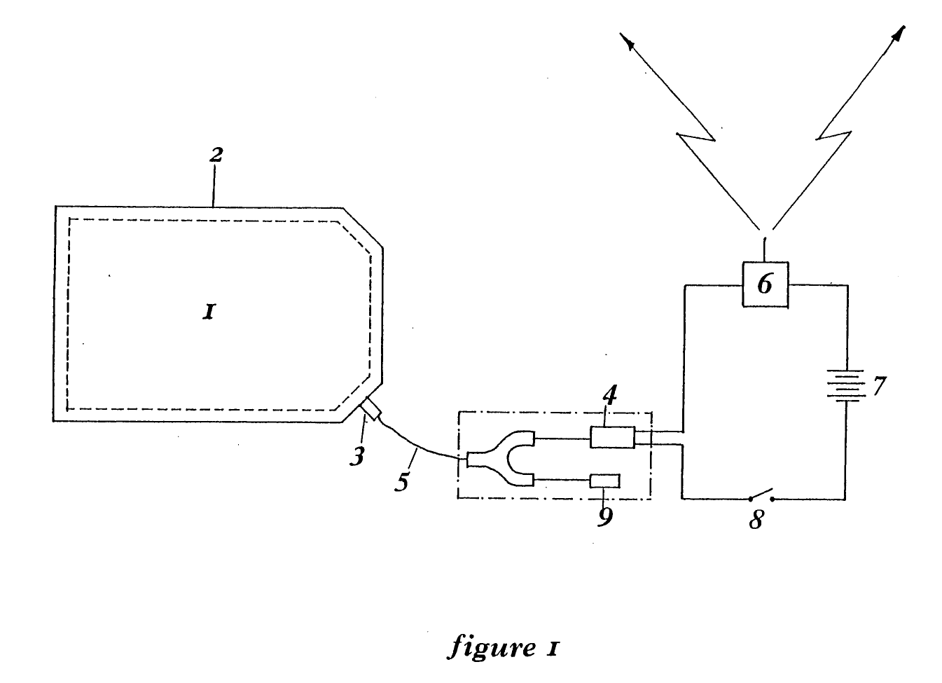

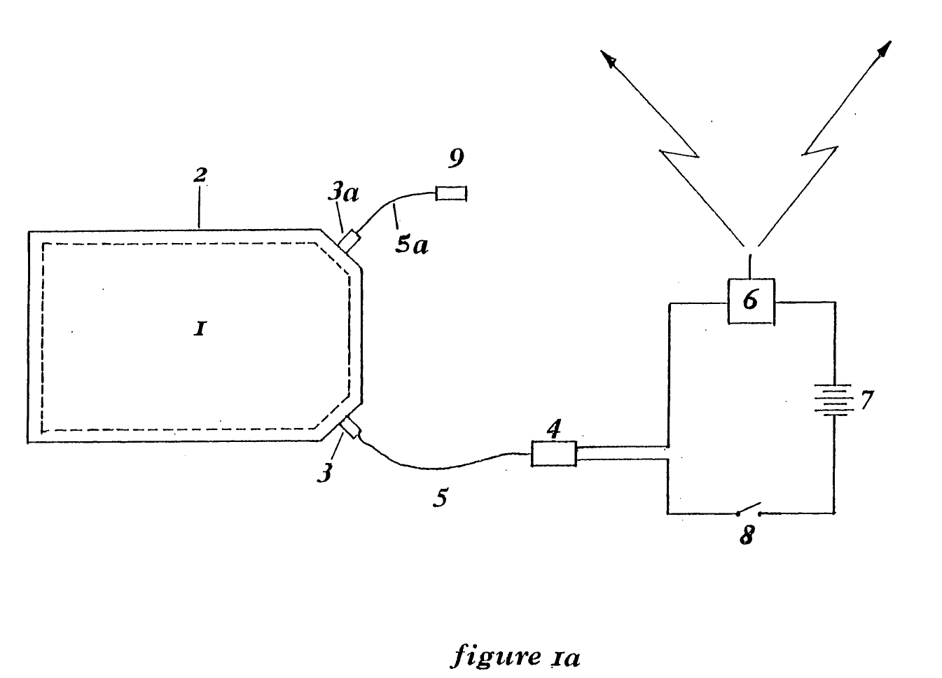

FIG. 1 is a diagram showing an embodiment of the system of the invention;

FIG. 1a is a diagram illustrating an alternative embodiment of the system of the invention;

FIG. 1b is a diagram illustrating a further alternative embodiment of the system of the invention

FIG. 2 is a section through an arrangement of a pressure release valve for use in the system of the invention;

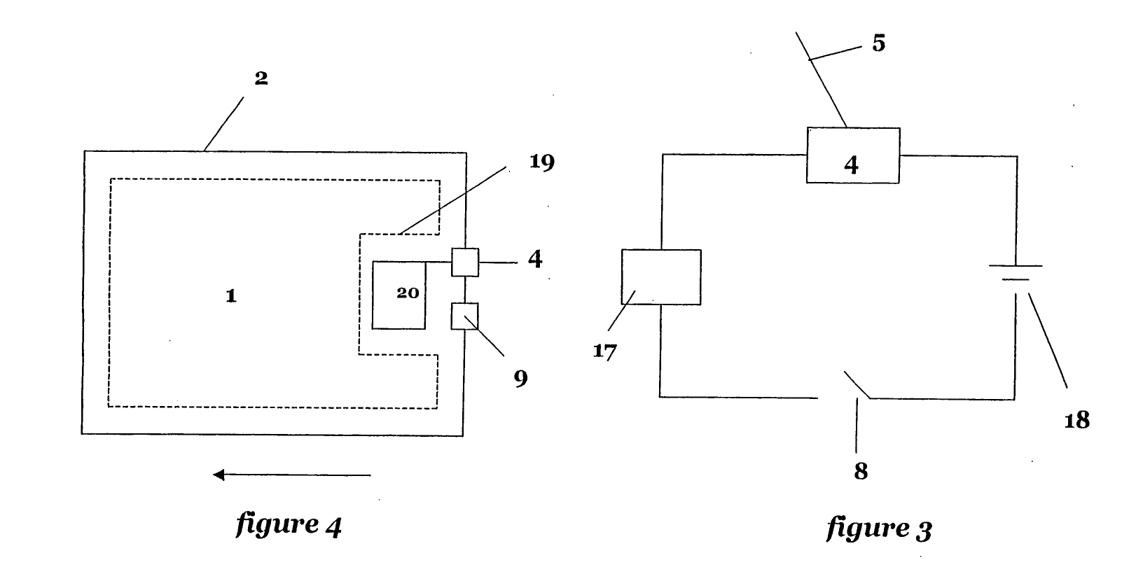

FIG. 3 illustrates an alternative circuit useful in an embodiment of the invention; and

FIG. 4 is a diagram showing an alternative embodiment of the invention in which the signalling system is by radio.

The diagram of FIG. 1 (not to scale) shows a foam mattress (1) sealed within a gas impermeable cover (2). An air inlet/outlet pipe with tube connector (3) is integrated into a seam of the cover (2) on its perimeter.

This air inlet/outlet pipe with tube connector (3) is connected by way of a flexible pneumatic tube (5) of suitable size for the intended application, for example 4 mm, to a tube ‘Y’ junction connector. A tube is then taken from each arm of the connector to a pressure relief valve (9) and to a pressure/vacuum switch (4). The electrical contacts within the pressure/vacuum switch (4) can be the normally open (N.O.) or normally closed (N.C.) type depending on the particular arrangement being used.

The pressure/vacuum switch (4) forms part of a circuit which includes a transmitter (6) for radio-transmission to a receiver or pager(s) (not shown) as indicated by an arrow. The circuit also includes a power supply, in this case in the form of a battery (7) and a switch (8) which may be electro/mechanically or electronically locked.

In an alternative embodiment, the pressure/vacuum switch (4) is connected by hardwire to a ‘nursecall’ type system, via a suitable terminal point adjacent to the bed, as illustrated in FIG. 1b.

The diagram of FIG. 1a (not to scale) shows an alternative position for the location of the pressure relief valve (9). A second air inlet/outlet pipe with tube connector (3A) in the cover (2) can be connected to the pressure relief valve (9) by way of a second flexible pneumatic tube (5A).

In the embodiment of FIG. 1b, the pressure release valve is dispensed with. In this case, the pressure/vacuum switch 4 is arranged to allow air both to enter and leave the cover, and one or both of these events are monitored.

In use, the systems shown in FIG. 1 and FIG. 1a function in a similar manner. When a weight such as a person lies on the mattress (1), the foam is compressed within the cover (2) forcing air out through the air inlet/outlet pipe with tube connector (3, 3A respectively) and the non-return pressure release valve (9). In the case of the embodiment of FIG. 1b, air exits through the pressure/vacuum switch 4. In this case however, a coarse sensitivity adjustment control in the form of a valve with a screw down cap (10) is included, so as to provide extra flexibility where exceptional weights, for example of the person or an additional mattress applied to the pad, are involved.

If the weight is then removed from the mattress (1), the resilience of the foam will cause it to return to expand to its original relaxed shape. This reduces the pressure within the cover (2), creating a partial vacuum, in the mattress. This will result in the opening of the pressure/vacuum switch (4), allowing air to reenter the cover (2) by way of the tube (5) and the air inlet/outlet pipe with tube connector (3). In doing this however, the contacts within the pressure/vacuum switch (4), are closed, thus completing the circuit and causing the transmitter (6) to send a signal to the receiving device.

This signal will alert the carer and the patient can be attended to or the reason for the removal of the person from the bed or cot ascertained.

In particular the form of the pressure release valve for use in the system of the invention is illustrated in FIG. 2. This pressure relief valve (9) comprises a ball (11) which is arranged to locate in a valve seat (12) in the mouth of a channel (14) within the valve body (13). The ball (11) may be made of metal or a plastic material such as neoprene. Under normal pressure the spring (20) holds the ball (11) on to the valve seat (12). The channel (14) vents to the atmosphere by a side channel (15) when air is forced past the ball (11) and the spring (10) into the channel (14). The air passes through and around the spring (10) located in channel (14).

The body (13) of the pressure relief valve (9) is connectable to the flexible pneumatic tube (5) by way of a releasable locking device (16). When pressure is applied to the pad (1), air is forced out through the second flexible pneumatic tube (5) lifting the ball (11) from its seating (12) if the pressure is sufficient to overcome the spring loading. At that point if pressure is released from the pad, the foam within the cover expands attempting to draw air into the cover (2). The vacuum thus created causes the ball (11) to return on to the valve seat (12), closing channel (14) and thereby preventing further air from entering the system and leaving sufficient vacuum to operate the pressure/vacuum switch (4).

It can be seen that in this way, by adjusting the spring loading the sensitivity of the system may be changed.

FIG. 3 illustrates an alternative circuit, which may be used in the system of the invention. This circuit includes an alarm (17) such as a buzzer, hard wired into the circuit which includes the pressure/vacuum switch (4), which is connected to the pneumatic tube (5). As well as switch (8), it also includes a connector (18) to allow the circuit to be plugged into an existing patient monitoring system with a suitable adjacent connection point.

The foam mattress (1) of the embodiment of FIG. (4) includes a recess (19) which accommodates a complete radio-signalling system (20), which is electrically connected to the pressure/vacuum switch (4). In this case, both the pressure/vacuum switch (4) and the pressure release valve (9) are integrated into the edge or seam of the cover (2).

If desired, a flap of material (not shown) may be provided so that it covers the valve (9), the switch (4) and the system box (20)

This embodiment is more discrete, so that a person may not be aware that their movements are being monitored.

Suitably the mattress (1) is rolled up in the direction of the arrow for storage. Velcro™ binding strips may be provided on the undersurface of the mattress and arranged to secure it in the rolled configuration. Thereafter, it may be placed within a suitably sized bag or cover until required.

1. An alarm system comprising a resilient foam pad contained within a cover, said cover being provided with air flow detector arranged to detect air leaving the cover in response to the application of a weight to the foam pad, and/or air entering the cover in response to the removal of the said weight, and signalling means responsive to said detector.

2. An alarm system according to claim 1 wherein the air flow detector comprises a pressure/vacuum switch.

3. An alarm system according to claim 1 wherein the detector further comprises a non-return pressure release valve arranged to allow air to be-released from the cover when pressure is applied to the pad.

4. An alarm system according to claim 1 wherein the cover is gas-impermeable.

5. An alarm system according to claim 2 wherein the signalling means is responsive to the opening of the pressure/vacuum switch or to movement of air into the cover through the pressure/vacuum switch.

6. An alarm system according to claim 5 wherein the pressure/vacuum switch contains a pair of electrical contacts arranged within a chamber, at least one of the contacts being-moveable in response to a reduction in pressure within the chamber, to bring the contacts together and thus close an electrical circuit.

7. An alarm system according to claim 1 wherein the pad with the cover, constitutes a mattress.

8. An alarm system according to claim 1 which is adapted to be used in conjunction with a conventional mattress and wherein the pad extends across substantially the surface area of the mattress.

9. An alarm system according to claim 7 wherein the mattress is rollable for storage purposes, and retaining means are provided to hold the mattress in the rolled configuration.

10. An alarm system according to claim 1 wherein the signalling means comprises an alerting device which gives an audible signal, a visible signal or a combination of these.

11. An alarm system according to claim 1 wherein the signalling system is hard wired to the circuit containing the pressure/vacuum switch or the pressure release valve.

12. An alarm system according to claim 1 wherein the signalling system includes a radio-transmitter device, and a compatible signal receiving system.

13. An alarm system according to claim 12 wherein the signal receiving system comprises a radio-pager and the system further comprises a transceiver to convert the VHF signal to a UHF signal which can be received by the pager.

14. An alarm system according to claim 1 wherein the signalling system comprises a connector, suitable for plugging into a preexisting signalling system.

15. An alarm system according to claim 1 which further comprises means for actuating the signalling system.

16. An alarm system according to claim 15 wherein the actuating system includes an electronic locking system, which may be operated by entering an identification code.

17. An alarm system according to claim 1 wherein the signalling system is accommodated within a recess in the pad on the inside of the cover.

18. An alarm system according to claim 1 wherein the cover further includes coarse sensitivity adjustment means.

19. An element adapted for use in the system of claim 1 comprising a pad within a cover, said cover having with at least one air inlet/outlet pipe with a pneumatic tube connector.

20. An element according to claim 19 wherein the cover is a gas-impermeable cover.

21. A pressure release valve and/or a pressure/vacuum switch suitable for connection to the element of claim 19 by way of a pneumatic tube.

22. An alarm system comprising a resilient foam pad contained within a gas-impermeable cover, said cover being provided with a non-return pressure release valve, arranged to allow air to be released from the cover when pressure is applied to the pad, and a pressure/vacuum switch arranged to open to allow air to enter the cover when the air pressure within the cover drops below ambient pressure, and signalling means responsive to the opening of the pressure/vacuum switch or the pressure release valve, or to the movement of air through said pressure/vacuum switch or pressure release valve.

23. Canceled.
